(19) United States
(12) Patent Application Publication
(10) Pub. No.: US 2004/0207551 A1
(43) Pub. Date: Oct. 21, 2004

(54) Smoke detector with rf reset switch

(76) Inventor: Bernard Vining, Chicago, IL (US)

Correspondence Address: BERNARD VINING, 6419 South Troy Street, Chicago, IL, 60629, US

(21) Appl. No.: 10/080,260

(22) Filed: Feb. 21, 2002

Related U.S. Application Data
(60) Provisional application No. 60/271,125, filed on Feb. 26, 2001.

(51) Int. Cl. H04L 17/02; G08C 19/12

(52) U.S. Cl. 341/176; 340/628

(57) ABSTRACT

Single smoke detector unit with rf radio frequency communication ability, designed to protect a single room or area in a building of smoke hazard conditions. When unit is energized repeatly during false alarm smoke hazard conditions, occupant or user's have the option of resetting unit, by manual switch located on unit, or by hand held transmitter remote control rf radio frequency tuned switch on unit. An intentional time delayed period designed, to avoid smoke detector unit from immediately re-actuating during detecting of smoke hazard conditions.

### FIELD OF THE INVENTION

The present invention relates to smoke detector reset switches in general; and more particularly, relates to a smoke detector used in a building to isolate the source of the smoke in a single room or area where smoke is detected. With the present smoke detector, a occupant or user in the room or area in which the smoke is detected can immediately reset smoke detector unit by means of radio frequency (rf) transmitter remote control unit switch.

### SUMMARY OF THE INVENTION

In typical residential or commercial smoke detector unit, there is a manual reset switch located on most units. When smoke detector becomes energized and usually generates a distinctive audible signal to alert users or occupants, one with a less measure of height or disadvantage find it difficult to reset manual switch on unit. The primary shortcoming of this type of manual reset switch, is that a person of an lesser height or disadvantage person may find it difficulties doing a false alarm to repeat elevating to heights in order to reset manual switch on unit. The distinctive audible signal usually repeat itself as often as smoke particles remains in smoke detector chamber.

The present invention is designed to overcome these shortcomings, whereby some users or occupants of an certain height is able to reset smoke detector unit by manual switch and persons of a lesser height or disadvantage have the convenient of resetting triggered unit by other means. The instant invention is designed to communicate by means of radio frequency (rf) signal, that is the smoke detector includes receiver circuit that have (rf) ability to communicate with an hand held transmitter circuit. When false alarm smoke is detected in a room or area a visual signal appear on smoke detector unit indicating the detector had been triggered by smoke particles. The users or occupant than have the option of resetting unit by manual switch on the unit or by radio frequency (rf) transmitter remote control switch on unit. By pressing manual switch once a low signal is generated inhibiting smoke detector, and by pressing (rf) switch on transmitter remote control unit once that generates a radio frequency signal that actuates smoke detector receiver circuit, causing the output momentarily to switch states inhibiting smoke detector. When smoke detector is reset, a signal is generated to re-actuate a timer which provides a short intentional delay, after which if smoke particles are still in chamber, smoke detector re-generates an audible signal. Other features and advantages of the present invention will be apparent to personal skilled in the art from the following detail disclosure of one embodiment accompanied by the attached drawing where identical reference numerals will refer to like parts in the various views.

### BRIEF DESCRIPTION OF THE DRAWINGS

FIG. 1.1 drawing is an electrical schematic diagram of the smoke detector unit which would be located in a single room or area.

FIG. 1.2 drawing is an electrical schematic diagram of the rf receiver circuit part of smoke detector unit.

FIG. 1.3 drawing is an electrical schematic diagram of the transmitter circuit which would be used as an hand held remote control unit.

FIG. 1.4 drawing is an Smoke Detector and Transmitter Remote Control unit illustrating finish manufacture production, which will be used to protect a single room or area.

### DETAILED DESCRIPTION OF THE ILLUSTRATED EMBODIMENT

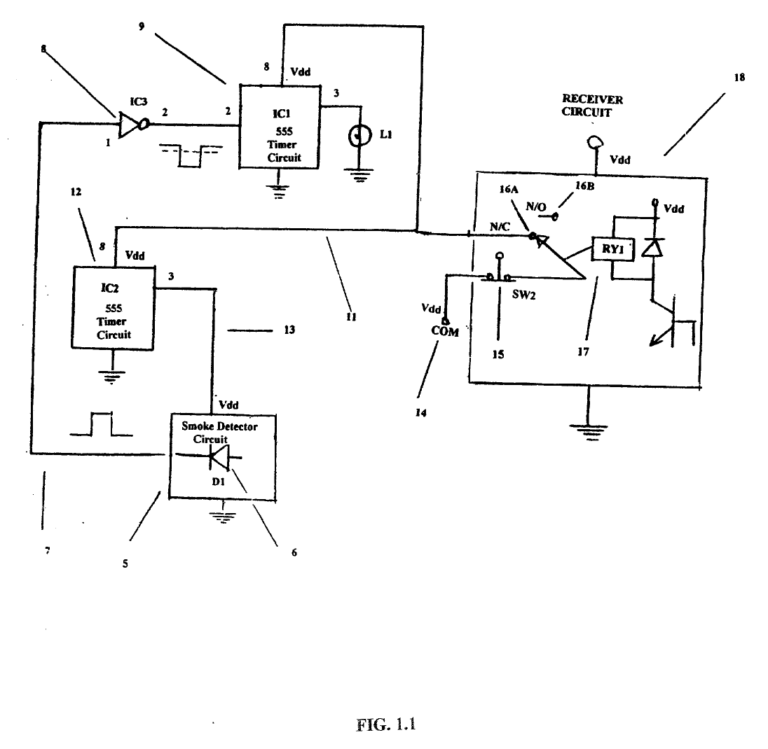

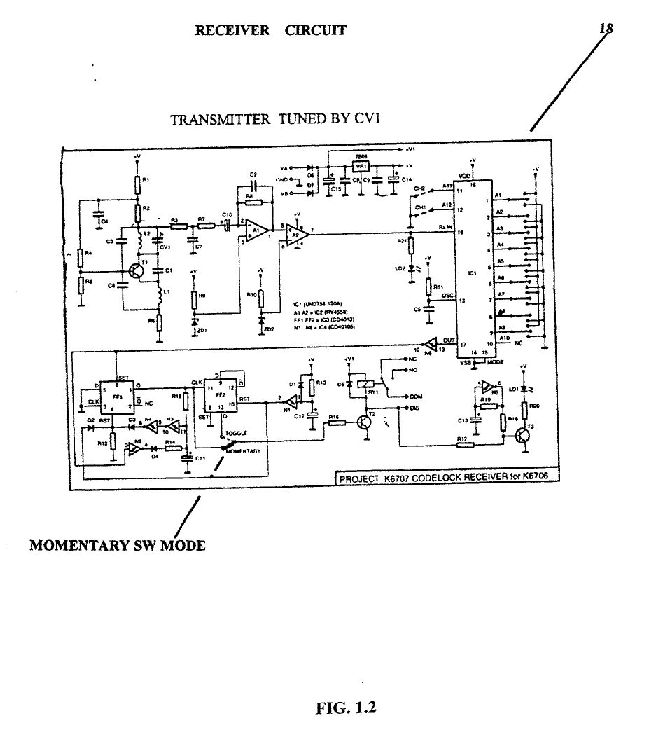

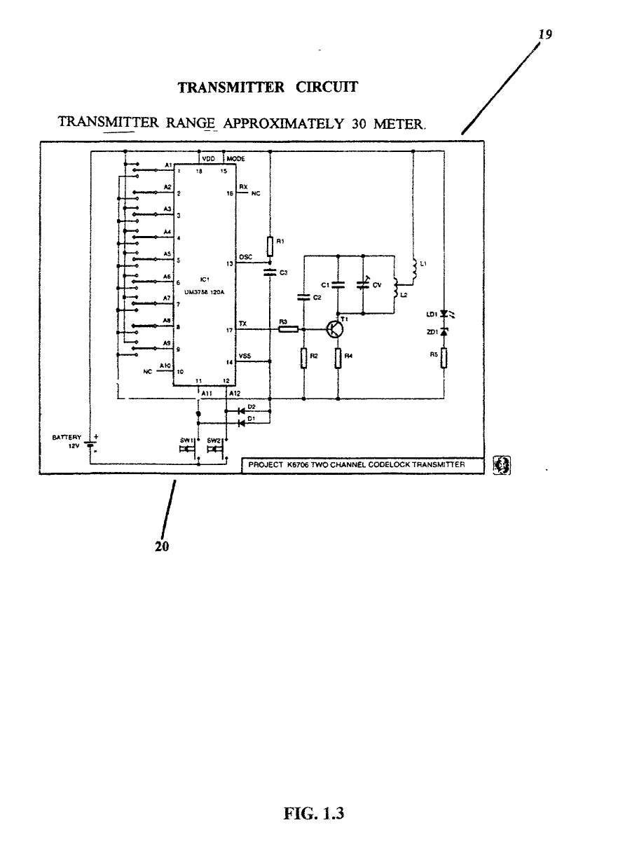

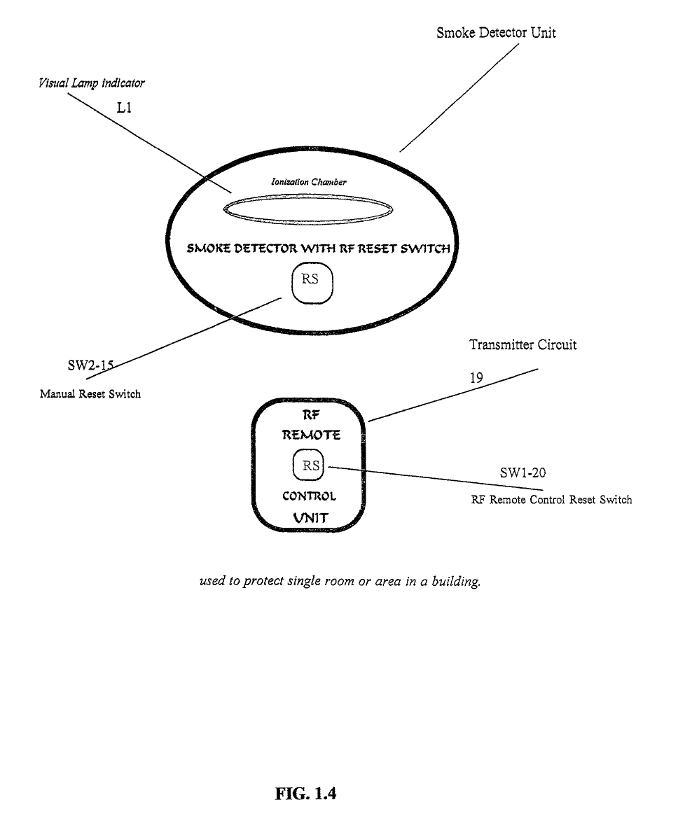

Turning now to the drawing in FIG. 1.1, there is shown an electrical schematic diagram, partly in functional block form, of a smoke detector unit incorporating the present invention. That is, the unit such as shown in the drawing would be located in a room or area of a house, apartment or other building intended to be protected. It is not necessary, according to the owner or user's desires, that every room or area contain such detector unit. It would be most preferred where false alarms commonly occurs, such as, kitchens, restaurants, cooking areas and related areas as such is needed. In the drawing FIG. 1.1, reference numeral 5 designates a smoke detector. The smoke detector 5 is of conventional design and may be obtained commercially, as is the case with all of the individual circuits disclosed herein. As is known, the smoke detector 5 includes an ionization chamber in which ionized particles are created and the particles move under an electrical current. When smoke enters the ionization chamber, the smoke particles attached to the ionized particles, neutralizing the electrical charge and thereby decreasing the magnitude of the current flowing. The smoke detector senses the reduction in electrical current between energized plates in the ionization chamber and generates an output signal coupled through a diode 6 to an output line 7. When smoke is detected by the smoke detector 5, a positive-going pulse is generated on the output line 7 and fed to the input of an inverter 8, the output of which is coupled to the trigger input of the first timer 9. The output signal of the inverter 8 actuates the first time circuit 9 when a pulse is detected from the smoke detector 5, the output signal of the first timer circuit is a high pulse which is connected to lamp indicator 19. The first timer 9 is a conventional momostable circuit known in the art as a 555 timer, and it generates an positive output pulse for one-hundred and eighty seconds. The relay 17 FIG. 1.2 has normally closed (N/C) contacts 16A and normally open (N/O) contacts 16B acting as the output. The power source COM 14 is connected to switch 15 which is incorporated in the receiver 18 N/C, connected to the normally closed contacts 16A of the receiver circuit 18 is connected along line 10 to the power input of the first timer 9 and along line 11 to the power input of the second timer 12. The second timer 12 is a conventional momostable circuit known in the art as a 555 timer, and it generates an positive output pulse, after the sixteen seconds time delay interval is completed. The output of the second timer 12 is connected along line 13 to the power input of the smoke detector circuit 5. Receiver 18 FIG. 1.2 and the transmitter FIG. 1.3 are tuned to operate on the same frequency. The transmitter and receiver discussed may be conventional circuits such as code lock receiver for K6706 and code lock two channel transmitter, both of which are commercially available and FIG. 1.2 and FIG. 1.3.

Operation

Before describing the operation of the circuitry in detail, it will be pointed out that the function of the sixteen seconds delayed timer 12 is to avoid smoke detector from instantly re-actuating and generating audible signal When the smoke detector 5 FIG. 1.1 detects the existence of smoke, it energizes or triggers, through the inverter 8, the first timer 9. The output of the timer circuit 9 turns on visual signal indicator and remains on until timer times out or smoke detector is reset. To reset the unit by manual switch 15, by pressing manual switch 15 once which is incorporated in receiver circuit 18 FIG. 1.2, inhibiting COM 14 voltage signal to (N/C) 16A that supplies the power signal along line 10 to the first timer 9 and along line 11 that supplies the second timer 12 resetting unit. Doing this state, when the second timer 12 power input signal is switched low, 12 output signal goes low along line 13, inhibiting smoke detector 5, and output signal of the first timer 9 is inhibit also, turning off visual signal indicator L1 doing this instant. When SW2 15 returns to normal state, the voltage signal is re-applied along line 10 to the first timer 9 and along line 11 to the second timer 12. After timer 12 intentional sixteen seconds time delay interval is completed, timer 12 output signal returned high along line 13, re-powering smoke detector 5. After which, if smoke particles remains in detector chamber, smoke detector 5 is than re-energizes generating an audible signal. To reset the unit by radio frequency (rf) remote control switch SW 20 located in transmitter circuit 19 FIG. 1.3. By pressing rf switch 20 once of the transmitter circuit 19, transmitter circuit 19 energized, generates a radio frequency signal to actuate the receiver circuit 18, causing receiver circuit 18 output RY1 17 to energized, and momentarily switch states resetting unit. The receiver circuit 18 switch mode is connected in the momentary switch, whereas, when RY1 17 of the receiver circuit 18 is energized the N/C 16A is switched low momentarily, inhibiting COM 14 voltage signal that supplies the power signal along line 10 to the first timer 9 and along line 11 that supplies the second timer 12 resetting unit. Doing this state, when the second timer 12 power input is momentarily switched low, 12 output signal goes low along line 13, inhibiting smoke detector 5, and output signal of the first timer 9 is inhibit also turning off visual signal indicator 19 doing this instant. When switch 20 momentarily returned to normal state, the voltage signal is re-applied along line 10 to the first timer 9 and along line 11 to the second timer 12. After timer 12 intentional sixteen seconds time delay interval is completed, timer 12 output signal along line 13 returned high, repowering smoke detector 5. After which if smoke particles remains in detector chamber, smoke detector 5 is than re-energizes generating an audible signal.

What is claimed is:

1) Smoke detector with rf reset switch, said have rf radio frequency communicate ability, designed to protect a single area or room in a building, said can be reset, by hand held rf transmitter unit, said further inhibiting smoke detector unit during smoke hazard conditions.

2) Smoke detector with rf reset switch as in claim 1, single smoke detector unit used to detect smoke hazard conditions, are incorporating parts; including commerical smoke detector unit for detections smoke particles, said inbodied with ionization chamber and audible alarm to alert of isolated smoke hazard conditions.

3) Smoke detector with rf reset switch as in claime 1, further including commerical receiver circuit, said for receiving transmitted rf radio frequency tuned codelock signal said from rf radio frequency tuned codelock transmitter circuit.

4) Smoke detector with if reset switch as in claimed 1, including hand held transmitter circuit, said for transmittng rf radio frequency codelock signal to smoke detector unit receiver circuit, said further inhibiting smoke detector unit during smoke hazard conditions.

5) Smoke detector with rf reset switch as in claim 1, including visual signal indicator, said to further identify smoke hazard conditions.

6) Smoke detector with rf reset switch as in claim 1, including manual switch, said for to further inhibiting smoke detector unit during smoke hazard conditions.

7) Smoke detector with rf reset switch as in claim 1, including timer delayed circuit, said for preventing smoke detector unit from instantly re-actuating.
